(19) United States
(12) Patent Application Publication
(10) Pub. No.: US 2016/0078775 A1
(43) Pub. Date: Mar. 17, 2016

(54) Color Sample Device and Method of Manufacture

(71) Applicant: Duha Color Services Limited, Winnipeg (CA)

(72) Inventor: Emeric J. Duha, Winnipeg (CA)

(21) Appl. No.: 14/823,712

(22) Filed: Aug. 11, 2015

Related U.S. Application Data
(60) Provisional application No. 62/049,042, filed on Sep. 11, 2014.

(51) Int. Cl. G09B 11/00; B05D 3/12; B05D 5/06; B05D 1/28

(52) U.S. Cl. CPC G09B 11/00; B05D 1/28; B05D 3/12; B05D 5/06

(57) ABSTRACT

A color sample device has a substrate having a front surface, a back surface opposite from the front surface, a top edge, a bottom edge opposite from the top edge, and two side edges which are laterally opposed from one another. A primary color sample coating is applied to an upper portion of the front surface of the substrate adjacent to the top edge so as to fully span between the two side edges. A plurality of secondary color sample coatings are applied to a lower portion of the front surface of the substrate between the primary color sample and the bottom edge. The primary color sample coating is a stripe coating applied directly to the substrate. The secondary color sample coating is deposit coating applied directly to the substrate.

This application claims the benefit under 35 U.S.C.119(e) of U.S. provisional application Ser. No. 62/049,042, filed Sep. 11, 2014.

### FIELD OF THE INVENTION

The present invention relates to a novel color sample device and method for fabricating the same, and more particularly to a color sample device produced by employing three separate and unique processes for transferring tinted fluid onto a color sample bearing card or other color sample display means.

### BACKGROUND

Color sample devices typically comprise colored patterns directly transferred to a color sample display card and/or colored chips (swatches) affixed to display cards to produce arrays of color samples, each identified so that a consumer may order paint of a particular color after visually examining the samples on the cards. According to prior art methods, the samples are manufactured by either: i) stripe coating; or ii) depositing. Stripe Coating generally involves applying a tinted fluid film by knife over plate, knife over roll, or reverse roll coating heads. The film thickness can vary from 0.003″ to 0.007″ wet film thickness. It is then passed through an oven which allows for the coating to cure before the next operation. According to an injection method, depositing, or deposit coating, involves applying a tinted fluid directly onto a sheet by forcing the fluid into an empty cavity leaving a shaped film on the sheet which can vary in wet film thickness from 0.009″ to 0.016″. It is then either air-cured, oven-cured, or a combination of both methods before the next operation. Alternatively, deposit coating may involve a silk screening operation to deposit the fluid onto the sheet. Each method has limitations as to the kind of display sheet which can be created. Although stripe coating is quick and can cover large areas, it requires that the color sample run continuously across the full width of a sample card produced when a continuous sheet is cut after coating. In contrast, deposit coating requires that the coating be deposited within prescribed boundaries and is limited in the overall sample size that can be produced.

One common use of color sample devices is to display paint color selections to consumers. Due to the limitations of the known methods for producing color sample sheets and cards, one common layout for color samples on display cards is to provide a row of color samples, for example 5 or 6, on a single card with all color samples being similarly sized to accommodate use of the selected coating technique described above. The cards are then displayed in display racks so that all of the colours are visible, but in a manner which tends to overwhelm consumers due to the large volume of colors being simultaneously displayed.

### SUMMARY OF THE INVENTION

It is an object of the present invention to overcome some of the limitations imposed by traditional processes alone and potentially create new and dynamic designs for color sample devices going forward.

According to one aspect of the present invention there is provided a method of manufacturing a color sample device comprising:

providing a substrate having a front surface and a back surface opposite from the front surface;

stripe coating at least one primary color sample coating directly onto a portion of the front surface of the substrate; and deposit coating at least one secondary color sample coating directly onto another portion of the front surface of the substrate.

The method may further include printing i) directly onto the front surface of the substrate, ii) overtop of said at least one primary color sample coating, and/or iii) directly onto the rear surface of the substrate, before deposit coating onto the substrate.

According to a second aspect of the present invention there is provided a color sample device manufactured according to the method described above.

According to a further aspect of the invention there is provided a color sample device comprising:

a substrate having a front surface, a back surface opposite from the front surface, a top edge, a bottom edge opposite from the top edge, and two side edges which are laterally opposed from one another;

a primary color sample coating applied to an upper portion of the front surface of the substrate adjacent to the top edge so as to fully span between the two side edges; and a plurality of secondary color sample coatings applied to a lower portion of the front surface of the substrate between the primary color sample and the bottom edge.

The method according to the present invention is generally described herein as the Striposit method of manufacture. The method of manufacture utilizes both fluid film applications described above (stripe coating and deposit coating) as well as offset printing on one side of color sample bearing card. On the opposite side of the color sample bearing card the process of four color process printing is performed.

The sequence for production would be according to the following steps:
1) stripe coating film application by knife on the front side (a);
2) Offset printing on the film side of the card on the front side (a) and four color process printing on the opposite rear side (b) of the card; and
3) deposit coating film application by forcing fluid into an empty cavity on the front side (a).

In creating the present invention, the first obstacle was to create a color sample device that allowed for a smooth, consistent surface while not forgoing color appearance. The deposit process is limited in terms of the size of a color swatch it can provide and still be considered commercially acceptable. Wash mark patterns in the color swatch begin to be noticeable as the deposit process parameters are exceeded. Hence, it was found to be desirable to include Stripe Coating for the largest color of the color sample device as size limitations for Stipe Coating are much larger.

The second obstacle to overcome in creating the present invention was to create a color sample device that allows for white dividing lines between all colors that is not of a stripe coating format. Stripe coating, allows only for horizontal white spacing. Depositing, as described earlier, allows for both horizontal and vertical white spacing, but is limited in the size of the samples. By combining both processes, a color sample device is created that allows for white dividing lines between all three colors that is not a stripe card format. Additionally, by combining these two processes, the amount of white space can be reduced between the largest color and two or more color choices presented on the same card.

The final obstacle overcome by the method of the present invention was to allow for a Color Name/Color Number to be printed on top of the stripe coated color without an extra pass through a printing press. By creating a color sample device as defined in steps 1 thru 3 above, an extra pass through a printing press is avoided resulting in reduced costs and improved delivery times.

Other achievements of Striposit include: i) Reduced production costs and improved environmental impact; and ii) Increased production speed beyond traditional methodologies in order to service layer market opportunities.

Some embodiments of the invention will now be described in conjunction with the accompanying drawings in which:

### BRIEF DESCRIPTION OF THE DRAWINGS

FIG. 1 is a partial top plain view of a typical color sample display card bearing a plurality of color samples.

FIG. 2 is a side elevation view of a color sample display card after application of the stripe coating to the substrate;

FIG. 3 is a side elevation view of the sample display card after printing on the front and rear sides of the card;

FIG. 4 is a side elevation view of a sample display card subsequent to application of the deposit coating as a final manufacturing step;

FIG. 5 is a front view of a finished color sample display card;

FIG. 6 is a front perspective view of the color sample display card in which the thickness of the substrate and coatings is exaggerated for illustrative purposes;

FIG. 7 is a rear perspective view of the color sample display card according to FIG. 6; and

FIG. 8 is a perspective view of a plurality of color sample display cards supported in an exemplary display rack.

In the drawings like characters of reference indicate corresponding parts in the different figures.

### DETAILED DESCRIPTION

Referring to the accompanying figures, there is illustrated a color sample display card generally indicated by reference numeral 10. The card 10 is used for displaying a plurality of color samples in which each color sample is presented in the form of a coating applied directly to a substrate in a fluid state and then is permitted to be dried or cured on the substrate.

The card 10 includes a substrate 12, for example a paper stock or other suitable base upon which coatings may be applied. The substrate is cut to form a rectangular planar body defining the card 10 such that it includes a front surface 14 and a rear surface 16 opposite from the front surface, which are joined to one another along a perimeter edge of the card. The perimeter edge includes a top edge 18 and a bottom edge 20 which span laterally between two opposing side edges 22 at opposing top and bottom ends of the card.

The card includes a single primary color sample coating 24 applied thereto so as to be rectangular in shape and so as to span an upper portion of the front surface of the substrate. More particularly, the primary color sample coating spans more than 50% of the surface area of the front surface such that it fully spans laterally between the two opposed side edges 22 and joins the top edge 18. The primary color sample coating is applied by stripe coating as described in further detail below.

The card also includes a plurality of secondary color sample coatings 26 applied to the front surface of the substrate at a lower portion of the card between the upper portion and the bottom edge of the card. Each of the secondary color sample coatings 26 is rectangular in shape so as to be identical in size and shape relative to one another while being collectively smaller in area than the primary color sample coating 24.

In the illustrated embodiment, only two secondary color sample coatings 26 are provided laterally spaced apart from one another such that each secondary coating 26 joins the bottom edge of the card and a respective one of the two side edges 22 of the card.

The secondary color sample coatings 26 are provided in a row which is spaced below the bottom edge of the primary color sample coating such that there is defined an uncoated white space separating each of the color sample coatings from one another. A first space 28 spans laterally across the full width of the card between the two side edges between the bottom edge of the primary color sample coating and the top ends of the row of secondary color sample coatings 26. A second space 30 extends vertically between the two secondary color sample coatings so as to be joined to the first space 28 at the top end and joined to the bottom edge of the card at the bottom end thereof. In addition to the coatings applied to the front surface of the substrate of the card, printing is also provided at various locations on the card to identify the color samples and provide other useful information to a customer. More particularly, offset printing 32 is provided on the front side of the card at a first location overtop of the dried coating forming the primary color sample coating 24. Additional offset printing 32 is provided directly on the front surface of the substrate adjacent to each one of the secondary color sample coatings 26 within the second space 30 to provide additional identifying information with regard to each of the secondary color sample coatings.

On the opposing rear surface of the substrate additional printing 34 is provided in the form of a four color process printing spanning substantially the entire rear side of the card. All of the printing steps are typically done subsequent to the application of the primary color sample coating, but before the application of the secondary color sample coatings as described in further detail below.

Manufacturing of the cards typically starts with the substrate being provided on a roll. The substrate is unrolled from the roll and several primary bands 36 of primary color sample coatings by a stripe coating technique, for example by using a knife to spread the coating along the substrate as it is unrolled. After application of the stripe coating, the unrolled substrate passes through suitable heating and drying equipment to cure and dry the primary coatings.

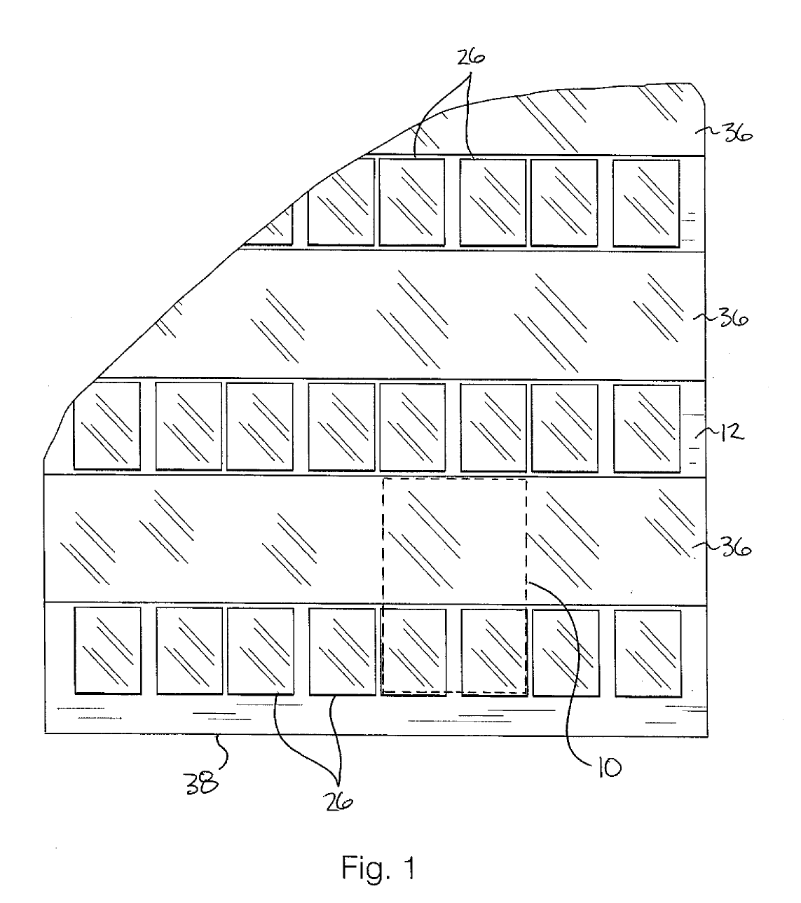

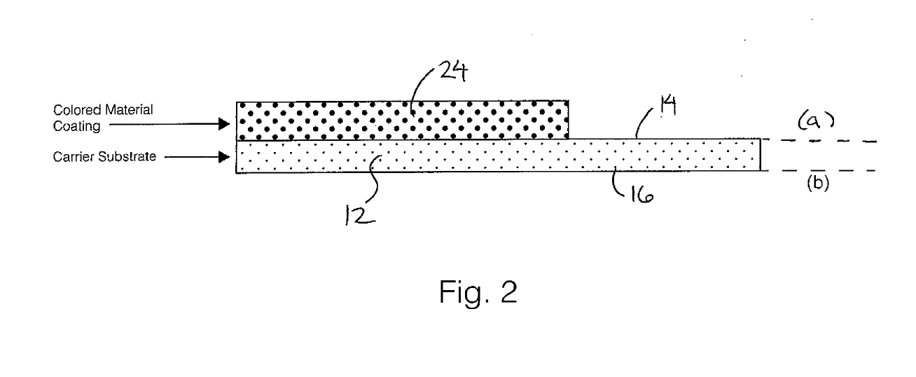

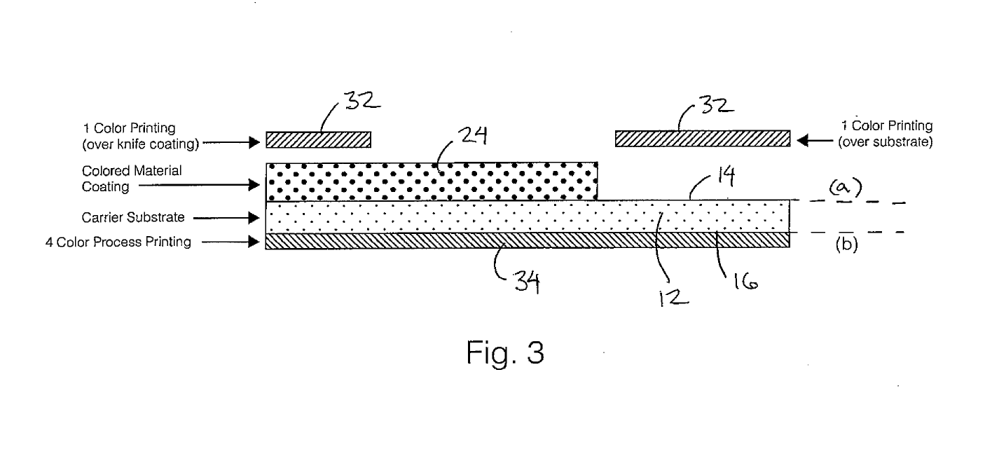

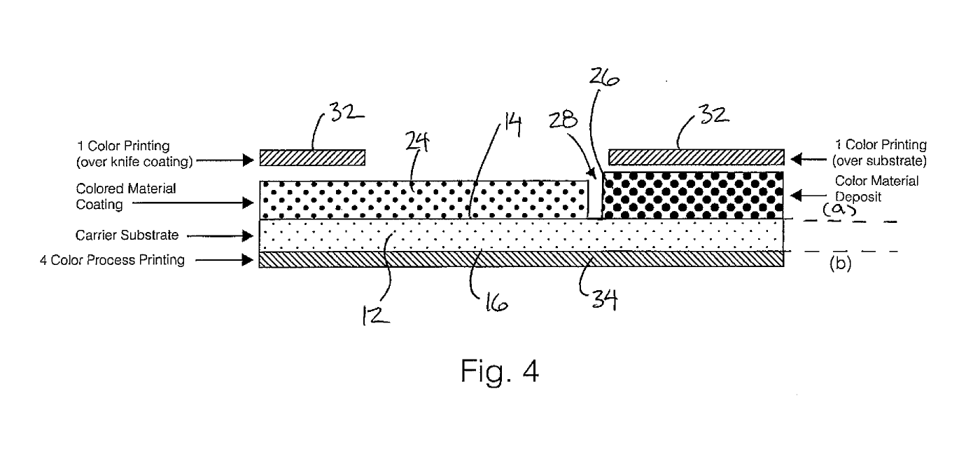

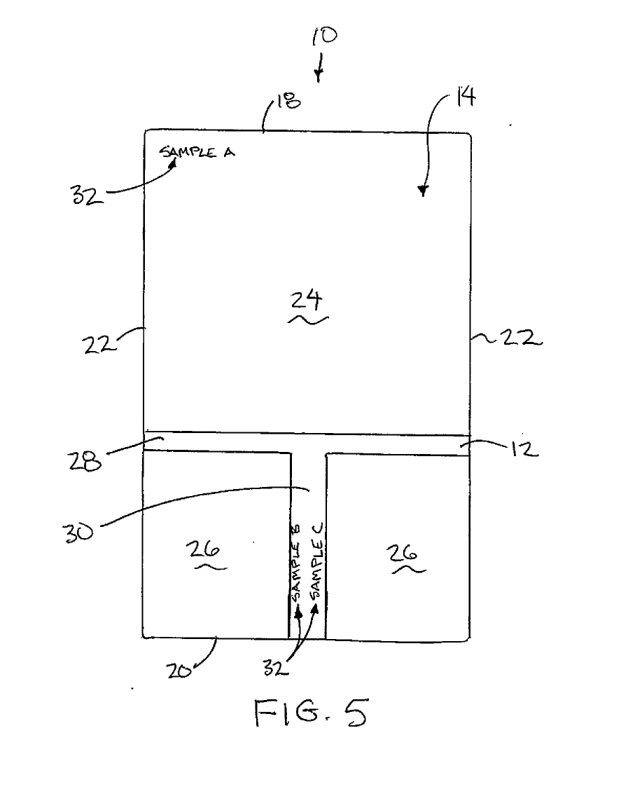

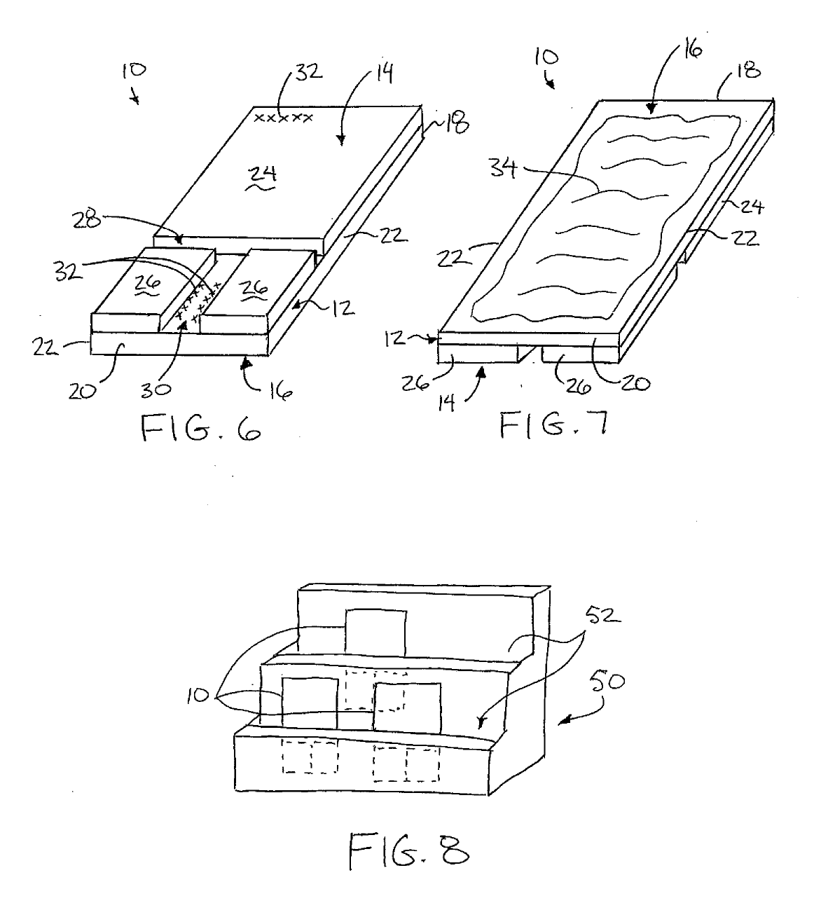

The unrolled substrate is then cut into manageable sized sheets 38 as shown in FIG. 1 in which each sheet is used to form a plurality of the cards 10. The cut sheets 38 are fed through printing processes to apply the offset printing 32 on the front of the card and to apply the four color process printing 34 to the rear of the card as described above.

The sheets are then fed into suitable equipment to permit deposit coating of the secondary color sample coatings 26 at prescribed locations on the sheets in the spaces between the primary bands 26. In preferred embodiments, the deposit coatings are applied using a mold plate pressed against the front side of the sheets which defined mold cavities into which tinted fluid is injected to deposit a film on the substrate. After separation of the mold plate from the substrate, the film is permitted to dry and cure using suitable heating and drying equipment. The sheets may then be cut into individual cards 10 such that each card has the characteristics described above.

The cards are suitably arranged such that when supported in a display rack 50 having a plurality of pockets 52 formed therein, the secondary color sample coatings 26 are arranged relative to the primary color sample coating 24 on each card such that only the primary color sample coating is visible to the consumer until the card is withdrawn from the respective pocket in the rack. In this manner, when presenting many color sample devices to a consumer, the number of initial color selections presented to the user is minimized for simplifying the initial color selection process. Only after the card is selected based on the primary color sample coating which is visible, is the consumer then presented with a finer selection of alternate shades of the color presented as secondary color sample coatings, or alternatively complementary color selections which might form the basis of a secondary color selection by the user.

Since various modifications can be made in my invention as herein above described, it is intended that all matter contained in the accompanying specification shall be interpreted as illustrative only and not in a limiting sense.

1. A color sample device comprising:
a substrate having a front surface, a back surface opposite from the front surface, a top edge, a bottom edge opposite from the top edge, and two side edges which are laterally opposed from one another;
a primary color sample coating applied to an upper portion of the front surface of the substrate adjacent to the top edge so as to fully span between the two side edges; and
a plurality of secondary color sample coatings applied to a lower portion of the front surface of the substrate between the primary color sample and the bottom edge.

2. The device according to claim 1 wherein the primary color sample coating is a stripe coating applied directly to the substrate.

3. The device according to claim 1 wherein the secondary color sample coating is deposit coating applied directly to the substrate.

4. The device according to claim 1 wherein the primary color sample joins the top edge.

5. The device according to claim 1 wherein the secondary color sample coatings are laterally spaced apart from one another.

6. The device according to claim 1 wherein the plurality of secondary color sample coatings comprises only two secondary color sample coatings such that each second color sample coating joins a respective side edge of the substrate.

7. The device according to claim 1 wherein each secondary color sample coating joins the bottom edge of the substrate.

8. The device according to claim 1 further comprising printing overtop of the primary color sample.

9. The device according to claim 1 further comprising printing directly on the front surface of the substrate adjacent to each one of the secondary color sample coatings.

10. The device according to claim 1 further comprising printing directly on the rear surface of the substrate.

11. The device according to claim 1 in combination with a display rack and a plurality of other color sample devices of like configuration, wherein the display rack comprises a plurality of pockets receiving the color sample devices therein, the secondary color sample coatings being located relative to the primary color sample coating on each color sample device such that only the primary color samples are visible when the color sample devices are received within the pockets of the display rack.

12. A method of manufacturing a color sample device comprising:
providing a substrate having a front surface and a back surface opposite from the front surface;
stripe coating at least one primary color sample coating directly onto a portion of the front surface of the substrate; and
deposit coating at least one secondary color sample coating directly onto another portion of the front surface of the substrate.

13. The method according to claim 12 further comprising providing the substrate on a roll and stripe coating at least one primary color sample coating directly onto a portion of the front surface of the substrate as the substrate is unrolled from the roll.

14. The method according to claim 13 further comprising cutting the substrate into sheets subsequent to stripe coating onto the substrate and before deposit coating onto the substrate.

15. The method according to claim 14 further comprising cutting the sheets into cards subsequent to deposit coating onto the substrate.

16. The method according to claim 12 further comprising printing directly onto the front surface of the substrate before deposit coating onto the substrate.

17. The method according to claim 12 further comprising printing overtop of said at least one primary color sample coating before deposit coating onto the substrate.

18. The method according to claim 16 further comprising printing onto the front surface of the substrate using offset printing.

19. The method according to claim 12 further comprising printing directly onto the rear surface of the substrate before deposit coating onto the substrate.

20. The method according to claim 19 further comprising printing onto the rear surface of the substrate using four color printing.
